(19) United States
(12) Patent Application Publication
(10) Pub. No.: US 2019/0219413 A1
(43) Pub. Date: Jul. 18, 2019

(54) PERSONALIZED ROADWAY CONGESTION NOTIFICATION

(71) Applicant: FORD GLOBAL TECHNOLOGIES, LLC, Dearborn, MI (US)

(72) Inventor: Kwaku O. PRAKAH-ASANTE, Commerce Township, MI (US)

(21) Appl. No.: 15/870,130

(22) Filed: Jan. 12, 2018

(51) Int. Cl. G01C 21/34; G08G 1/0967; G01C 21/36

(52) U.S. Cl. CPC G01C 21/3484; G08G 1/0967; G05B 15/02; G01C 21/3667; G01C 21/3697

(57) ABSTRACT

A system for a vehicle includes a positioning system configured to detect roadway congestion along a vehicle navigation route, and a controller configured to select a notification value that corresponds to a correlation between a time to the congestion and a vehicle driver type indicative of a predicted driver reaction time and, responsive to the value being greater than a first threshold, issue an alert having volume and brightness corresponding to the first threshold.

### TECHNICAL FIELD

The present disclosure relates to systems and methods for issuing a personalized roadway congestion notification.

### BACKGROUND

When a vehicle is following a navigation route, a vehicle operator may find it useful to be aware of a roadway congestion or a slowdown that may delay their arrival to a desired destination. Some navigation systems provide visual indication of a road congestion along the navigation route by changing a color of the roadway on an area map displayed on a vehicle center stack.

### SUMMARY

A system for a vehicle includes a positioning system configured to detect roadway congestion along a vehicle navigation route, and a controller configured to select a notification value that corresponds to a correlation between a time to the congestion and a vehicle driver type indicative of a predicted driver reaction time and, responsive to the value being greater than a first threshold, issue an alert having volume and brightness corresponding to the first threshold.

A method for a vehicle includes, responsive to detecting a roadway congestion, selecting a personalized notification value corresponding to a correlation between a period of time prior to reaching the congestion and a previously-stored user type indicative of a predicted driver reaction time, and, responsive to the value being greater than a first threshold, issuing a first alert having a first intensity corresponding to the first threshold, and, responsive to the value being greater than a second threshold, issuing a second alert having a second intensity corresponding to the second threshold and being different from the first intensity, wherein the first and second intensities include corresponding volume and brightness.

A system for a vehicle includes a positioning system configured to detect a roadway congestion along a navigation route being followed by the vehicle, and a controller configured to select a notification value that corresponds to a correlation between a period of time remaining prior to reaching the congestion and a vehicle driver type indicative of predicted driver reaction time and, responsive to the value being greater than a threshold, issue an alert having volume and brightness corresponding to the threshold and, responsive to the value being less than the threshold, prevent issuing the alert.

### BRIEF DESCRIPTION OF THE DRAWINGS

FIG. 1 is a block diagram illustrating a vehicle including a personalized traffic congestion notification system;

FIG. 2 is a block diagram illustrating a vehicle approaching traffic congestion;

FIG. 3 is a graph illustrating relative relationship between a personalized notification value, user type, and time to congestion;

FIG. 4 is a graph illustrating the personalized notification value with respect to a time to congestion; and

FIG. 5 is a flowchart illustrating an algorithm for issuing a personalized roadway congestion notification.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Notifying a vehicle occupant that the vehicle is approaching roadway congestion or a slowdown in traffic may call his or her attention to the changing on-road conditions. This may allow sufficient time for the occupant to lower the vehicle speed or stop the vehicle. For example, vehicle navigation display disposed in the center stack may provide a visual indication of roadway congestion through a change in roadway color along the navigation route, e.g., from green or neutral to red. Visual indications of roadway traffic may be accompanied by audio alerts, such as, but not limited to, speech, chimes, or other audible content. Visual and audio alerts may be activated when slowdowns occur along a navigation route currently being traversed by the vehicle, or when the slowdowns occur on any roadways within a predefined distance of the current vehicle location.

In some instances, congestion notifications may be issued according to a time-to-congestion derived from current vehicle speed and distance between the congestion and current vehicle location. However, issuing notifications at the same time, or the same distance-to-congestion, for all drivers and in all roadway conditions may be overly aggressive and unnecessary for some drivers while providing insufficient time to react for others. Thus, in addition to vehicle speed, notification times may vary based on individual user driving experience. Current roadway conditions and weather may, in some cases, influence whether or not a congestion notification is provided. Additionally or alternatively, the notification may be provided at one or more different instances in time prior to a time when the vehicle reaches the congestion.

Having a customer-centric vehicle notification system may improve overall customer experience. An example system and method may incorporate one or more system components that determine time and frequency of traffic congestion notifications alerting users of a roadway slowdown. As another example, the system and method may provide personalized driver awareness notifications based on factors, such as, but not limited to, time of day, time of year, roadway conditions, weather, driver type, and relevant driver behavioral indicators.

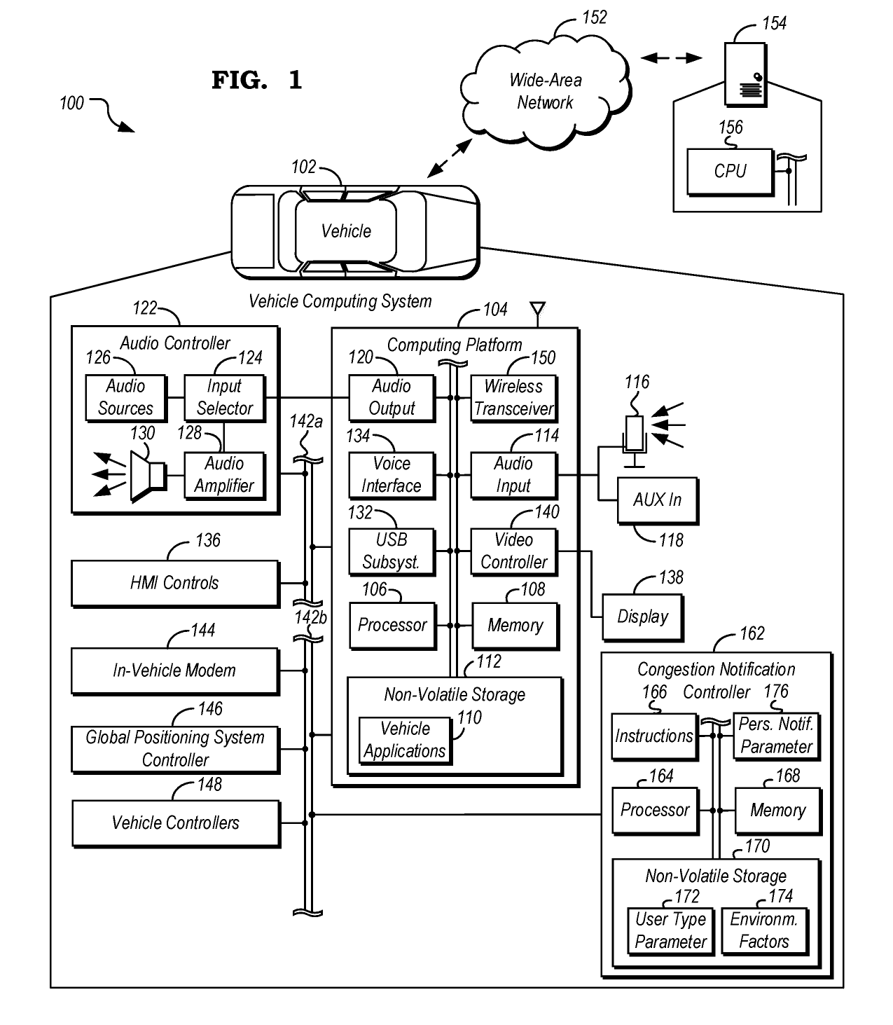

FIG. 1 illustrates an example diagram of a system 100 that may be used to provide telematics services to a vehicle 102. The vehicle 102 may be of various types of passenger vehicles, such as crossover utility vehicle (CUV), sport utility vehicle (SUV), truck, recreational vehicle (RV), boat, plane or other mobile machine for transporting people or goods. Telematics services may include, as some non-limiting possibilities, navigation, turn-by-turn directions, vehicle health reports, local business search, accident reporting, and hands-free calling. In an example, the system 100 may include the SYNC system manufactured by The Ford Motor Company of Dearborn, Mich. It should be noted that the illustrated system 100 is merely an example, and more, fewer, and/or differently located elements may be used.

A computing platform 104 may include one or more processors 106 connected with both a memory 108 and a computer-readable storage medium 112 and configured to perform instructions, commands, and other routines in support of the processes described herein. For instance, the computing platform 104 may be configured to execute instructions of vehicle applications 110 to provide features such as navigation, roadway congestion alerts, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory (e.g., tangible) medium that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be further configured to communicate with other components of the vehicle 102 via one or more in-vehicle networks 142. As shown, the computing platform 104 may communicate with a first set of vehicle systems, subsystems, or components over a first in-vehicle network 142a, and with a second set of vehicle 102 systems, subsystems, or components over a second in-vehicle network 142b. In other examples, the computing platform 104 may be connected to more or fewer in-vehicle networks 142. Additionally or alternately, one or more vehicle 102 systems, subsystem, or components may be connected to the computing platform 104 via different in-vehicle networks 142 than shown, or directly, e.g., without connection to an in-vehicle network 142.

The in-vehicle networks 142 may include one or more of a vehicle controller area network (CAN), an Ethernet network, or a media oriented system transfer (MOST), as some examples. The in-vehicle networks 142 may allow the computing platform 104 to communicate with other vehicle 102 systems, such as an in-vehicle modem 144, a global positioning system (GPS) controller 146 configured to provide current vehicle 102 location and heading information, and various vehicle controllers 148 configured to provide other types of information regarding the systems of the vehicle 102.

As some non-limiting possibilities, the vehicle controllers 148 may include a powertrain controller configured to provide control of engine operating components (e.g., idle control components, fuel delivery components, emissions control components, etc.) and monitoring of engine operating components (e.g., status of engine diagnostic codes); a body controller configured to manage various power control functions such as exterior lighting, interior lighting, keyless entry, remote start, and point of access status verification (e.g., closure status of the hood, doors, and/or trunk of the vehicle 102); a radio transceiver configured to communicate with key fobs or other local vehicle 102 devices; and a climate control management controller configured to provide control and monitoring of heating and cooling system components (e.g., compressor clutch and blower fan control, temperature sensor information, etc.).

A congestion notification controller 162 may be a vehicle controller 148 configured to provide to the computing platform 104 a signal indicative of a roadway congestion alert. Similar to the computing platform 104, the congestion notification controller 162 may include one or more processors 164 configured to execute instructions 166 loaded to memory 168 of the congestion notification controller 162 from storage medium 170. The congestion notification controller 162 may be configured to detect a traffic slowdown, e.g., along a navigation route currently being followed by the vehicle 102, and issue a personalized notification to the vehicle operator.

The congestion notification controller 162 may generate the roadway congestion alert based on one or more of user type parameters 172 stored within the storage medium 170. As some nonlimiting examples, the user type parameters 172 may include numerical values identifying experience level of the vehicle 102 operator, predicted reaction time, detected distraction level, and so on. The congestion notification controller 162 may be configured to determine whether a congestion alert should be generated, and at what time, prior to the vehicle 102 reaching the congestion, further based on one or more environmental factors 174 stored within the storage medium 170. Nonlimiting examples of the environmental factors 174 include factors indicative of current weather, roadway conditions, and so on.

In one nonlimiting example, the congestion notification controller 162 may issue a signal indicative of a personalized notification alert responsive to value of a personalized notification parameter (hereinafter, notification parameter) 176 being greater than a predefined threshold. The notification parameter 176 may correspond to a correlation between the user type parameters 172 and an amount of time remaining prior to reaching the congestion and current speed of the vehicle 102.

The computing platform 104 may communicate via a wide-area network 152 that provides communications services, such as packet-switched network services (e.g., Internet access, VoIP communication services), to devices connected to the wide-area network 152. An example of the wide-area network 152 may include a cellular telephone network. The computing platform 104 may, for instance, utilize the in-vehicle modem 144 of the vehicle 102 to connect to the wide-area network 152.

Via a connection with the wide-area network 152 or via another connection method, the computing platform 104 may be in communication with a weather and traffic server (hereinafter, server) 154 configured to receive current weather and roadway conditions requests from the vehicle 102 and generate and distribute to the vehicle 102 current roadway conditions and weather reports in association with the request. The server 154 and its components may be provided as software that, when executed by the CPU 156 of the server 154, provides the operations described herein. Alternatively, the server 154 and its components may be provided as hardware or firmware, or combinations of software, hardware and/or firmware. Additionally, it should be understood that the operations of the server 154 may be provided by fewer, greater, or differently named components.

The computing platform 104 may also be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a wired jack, such as a stereo input, or a wireless input, such as a Bluetooth® audio connection. In some examples, the audio input 114 may be configured to provide audio processing capabilities, such as pre-amplification of low-level signals, and conversion of analog inputs into digital data for processing by the processor 106.

The computing platform 104 may also provide one or more audio outputs 120 to an input of the audio playback functionality of the audio controller 122. In other examples, the computing platform 104 may provide audio output to the occupants through use of one or more dedicated speakers (not illustrated). The audio controller 122 may include an input selector 124 configured to provide audio content from a selected audio source 126 to an audio amplifier 128 for playback through vehicle speakers 130, as well as, include audio content generated by the computing platform 104, audio content decoded from flash memory drives connected to a universal serial bus (USB) subsystem 132 of the computing platform 104, audio content passed through the computing platform 104 from the auxiliary audio input 118, and so on. The computing platform 104 may utilize a voice interface 134 to provide a hands-free interface to the computing platform 104, as well as, support speech recognition, e.g., from audio received via the microphone 116 according to a grammar of available commands, and voice prompt generation for output via the audio controller 122.

The computing platform 104 may also receive input from human-machine interface (HMI) controls 136 configured to provide for occupant interaction with the vehicle 102, e.g., via one or more buttons or other HMI controls configured to invoke computing platform 104 functions. The computing platform 104 may also drive or otherwise communicate with one or more displays 138 configured to provide visual output to vehicle occupants by way of a video controller 140. In one example, the computing platform 104 may receive a signal from the congestion notification controller 162 indicative of an approaching roadway congestion and may generate a personalized notification on the display 138 responsive to the signal. The computing platform 104 may display the personalized notification, in addition to, or in place of, a corresponding audio notification, e.g., audio notification generated using audio output 120.

The computing platform 104 of the vehicle 102 may be configured to communicate with one or more mobile devices (not illustrated) positioned inside, outside, or within a predefined distance of the vehicle 102. Examples of the mobile devices may include, but are not limited to, cellular phones, tablet computers, smart watches, laptop computers, portable music players, or other portable computing devices capable of communication with the computing platform 104. In some examples, the computing platform 104 may include a wireless transceiver 150 (e.g., one or more of a BLUETOOTH controller, a ZigBee® transceiver, a Wi-Fi transceiver, etc.) configured to communicate with a compatible wireless transceiver of the mobile device.

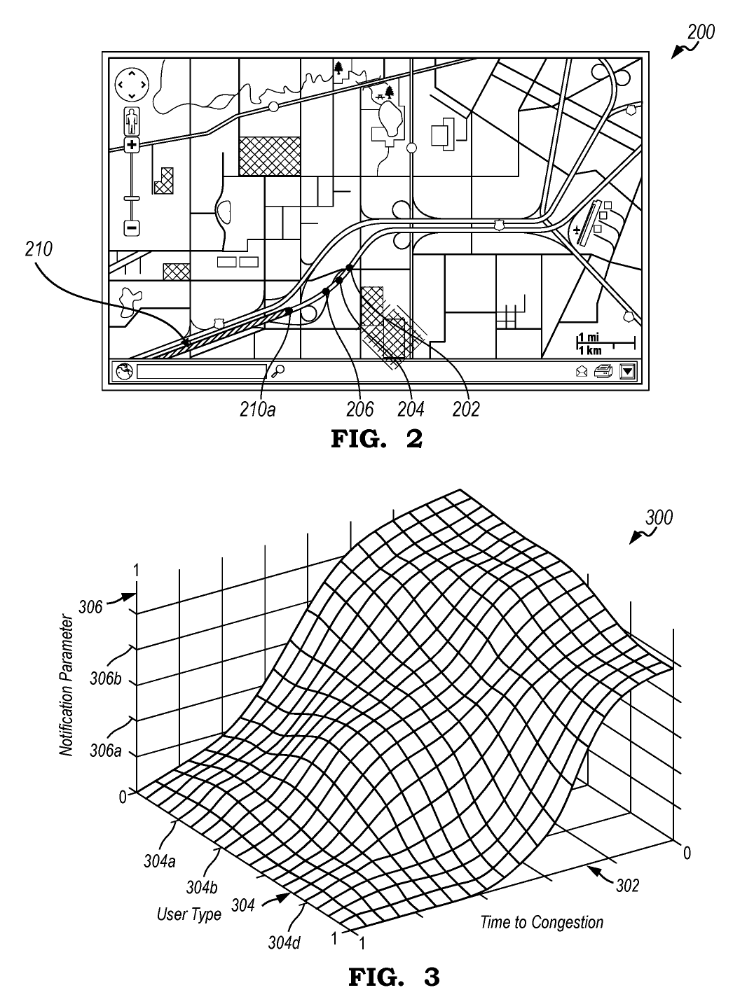

FIG. 2 illustrates an example roadway area 200 including a current vehicle 102 location 202 in proximity of a roadway congestion 210 relevant to the vehicle 102. The congestion notification controller 162 may be configured to determine whether the roadway congestion 210 being approached is relevant to the vehicle 102 based on, for example, but not limited to, current vehicle 102 direction of travel, current vehicle 102 navigation route, and so on. The congestion notification controller 162 may be configured to identify the roadway congestion 210 from one- or two-way data transmissions received by the vehicle 102 over radio frequencies, cellular network, e.g., the network 152, and so on.

The congestion notification controller 162 may be configured to determine that the roadway congestion 210 begins at a point 210a relative to the vehicle 102 current direction of travel. Responsive to detecting a relevant roadway slowdown, the congestion notification controller 162 may be configured to determine a value of the notification parameter 176 corresponding to the user type parameter 172 that identifies the driver of the vehicle 102 and a time to congestion. Additionally or alternatively, the congestion notification controller 162 may be configured to determine whether the value is greater than a predefined threshold adjusted according to the currently present environmental factors 174.

The user type parameter 172 may be a numeric or alpha-numeric identifier indicative of a predicted reaction time in frequently changing roadway conditions as defined, for example, by a level of driving experience, a number of driving hours logged, preferred driving style, and/or physical and physiological factors, such as, eyesight acuity, age, and so on. Example user type parameters 172 include, but are not limited to, one or more of novice, beginner, average, mid-range, proficient, experienced, expert, master, specialist, and professional.

In one example, the user type parameter 172 may be a numeric value within a range between a minimum value and a maximum value, e.g., a range between zero (0) and one (1), where the minimum value corresponds to a minimum amount of driving experience and/or a maximum amount of predicted reaction time and the maximum value corresponds to a maximum amount of driving experience and/or a minimum amount of predicted reaction time.

The user type parameter 172 may be manually selected by individual vehicle 102 operator, owner of the vehicle 102, vehicle 102 manufacturer, and so on. As one example, different user type parameters 172 may correspond to each keyless entry device, e.g., key fob, of the vehicle 102, each mobile device, etc., currently present in the vehicle 102. As another example, the congestion notification controller 162 may dynamically determine the user type parameter 172 for a current operator during a given ignition cycle of the vehicle 102 based on factors, such as, but not limited to, acceleration and braking profile, steering wheel angle change, following distance, and other sensor outputs.

The congestion notification controller 162 may be configured to analyze one or more environmental factors 174 that may affect the operator's ability to slow down the vehicle 102 prior to reaching the beginning of the roadway congestion 210a. Examples of the environmental factors 174 include, but are not limited to, factors external to the vehicle 102, such as, weather, time of day, season, geographic location, terrain type, roadway grade, elevation, and so on, and factors interior to the vehicle 102, such as, interior noise level contributors, e.g., current radio volume, active climate control settings, engine noise, and other sources of interior noise, and distraction level contributors, e.g., ongoing conversation among vehicle 102 occupants and/or occupant activity over cellular or data network connections.

Thus, the congestion notification controller 162 may be configured to issue a personalized congestion alert to a first user at a first distance to congestion D₁ 204 and to a second user at a second distance to congestion D₂ 206, wherein the first distance D₁ 204 is greater than the second distance D₂ 206 as considered with respect to the beginning of the congestion 210a. As one example, the congestion notification controller 162 may issue the alert to a novice driver at the first distance D₁ 204 and to an experienced driver at the second distance D₂ 206. While the first and second distances to congestion D₁ and D₂ 204, 206 are described in reference to FIG. 2 as distances at which the alerts are issued to the respective users, it is also contemplated that the distances to congestion D₁ and D₂ 204, 206 may be indicative of distances at which first and second alerts, respectively, are issued to a same user.

As one example, the congestion notification controller 162 may be configured to vary intensity of the first and second alerts as the vehicle 102 approaches the beginning of the roadway congestion 210a. Examples of intensity parameters may include, but are not limited to, volume of the alert, brightness of a visual indicator, or a number of notification sources used in the alert. In some instances, the first alert, e.g., an alert issued at the distance D₁ 204 to the congestion, may include a display 138 message rendered at a predefined brightness and an audio message, e.g., via the audio controller 122 output, rendered at a predefined volume. In some other examples, the second alert issued at the distance D₂ 206 to the congestion may include a display 138 message rendered at a different brightness and/or an audio message rendered at a different volume from those of the first alert. Additionally or alternatively, the second alert may include activating another in-vehicle user notification source, such as, but not limited to, a haptic seat feedback rendered at a predefined frequency. In some examples, the congestion notification controller 162 may be configured to change a time to congestion and/or distance to congestion at which to issue the alerts based on the currently present environmental factors 174.

FIG. 3 illustrates an example diagram 300 for determining a value of the notification parameter 176 corresponding to a correlation between the user type parameter 172 and a period of time prior to reaching the congestion 210a. The diagram 300 includes a first axis 302 indicative of a period of time remaining prior to reaching the congestion 210 (hereinafter, time to congestion 302), a second axis 304 indicative of the user type parameter 172 (hereinafter, user type 304), and a third axis 306 indicative of the notification parameter 176 (hereinafter, notification parameter value 306).

The time to congestion 302 may decrease from a maximum value, such as a value at a time when the congestion 210 is detected, to a minimum value, such as at or approaching zero (0) when the vehicle 102 reaches the beginning of the congestion 210a. The user type 304 value may range between zero (0) being indicative of a minimum driving experience and one (1) being indicative of a maximum driving experience. In one example, the user type 304a may be indicative of a novice driver, the user type 304b may be indicative of a driver with an average skillset, and the user type 304d may be indicative of an experienced driver. While user types are discussed as being based on levels of driving experience, other selection criteria, such as, but not limited to, physical and physiological characteristics and so on, are also contemplated.

Each instance of the notification parameter value 306 may correspond to one correlation value between the time to congestion 302 and the user type 304. In one example, the congestion notification controller 162 may be configured to provide the personalized congestion notification, or alert, according to Equation (1):

$$If ( t\_cong is {x}_{i} , and veh\_spd is {y}_{i} , and user\_type is {z}_{i} ) \\ then pers\_notif \_value = {m}_{i} , \qquad ( 1 )$$

where t_cong is a parameter indicative of a computed time-to-congestion, veh_spd is a parameter indicative of speed of the vehicle 102, user_type is a parameter indicative of a driver experience level, and pers_notif value is a parameter indicative of whether an alert is issued to the user.

The notification parameter value 306 may be indicative of a probability that an alert will be issued and may range from zero (0) when the probability of issuing an alert is smallest to one (1) when the probability is greatest. The notification parameter value 306 may further include one or more thresholds (illustrated generally as points 306a and 306b) having a corresponding intensity. The congestion notification controller 162 may be configured to determine a position of the thresholds, e.g., relative one another and/or relative to the zero position, based on the environmental factors 174 currently present. As an example, during adverse roadway conditions when the user reaction time and/or ability to quickly stop the vehicle 102 may be negatively affected, the congestion notification controller 162 may move the thresholds 306a and 306b to positions closer to zero on the notification parameter value 306 axis, while keeping relative positions of the thresholds 306a and 306b the same. Other adjustments to the positions of the thresholds, and adjustments made responsive to presence of different environmental factors 174, are also contemplated.

In one example, intensity of each issued alert may be the intensity corresponding to the threshold being exceed by the notification parameter value 306. In some instances, the intensity of the second alert, as compared to that of the first alert, may be greater when the notification parameter value 306 that corresponds to a given correlation between the time to congestion 302 and the user type 304 is greater than the threshold, e.g., as compared to, for example, when the corresponding notification parameter value 306 is less than the threshold. As another example, the intensity of the alert may increase when the corresponding notification parameter value 306 is greater than the second threshold 306b, e.g., as compared to when the corresponding notification parameter value 306 is greater than the first threshold 306a but less than the second threshold 306b.

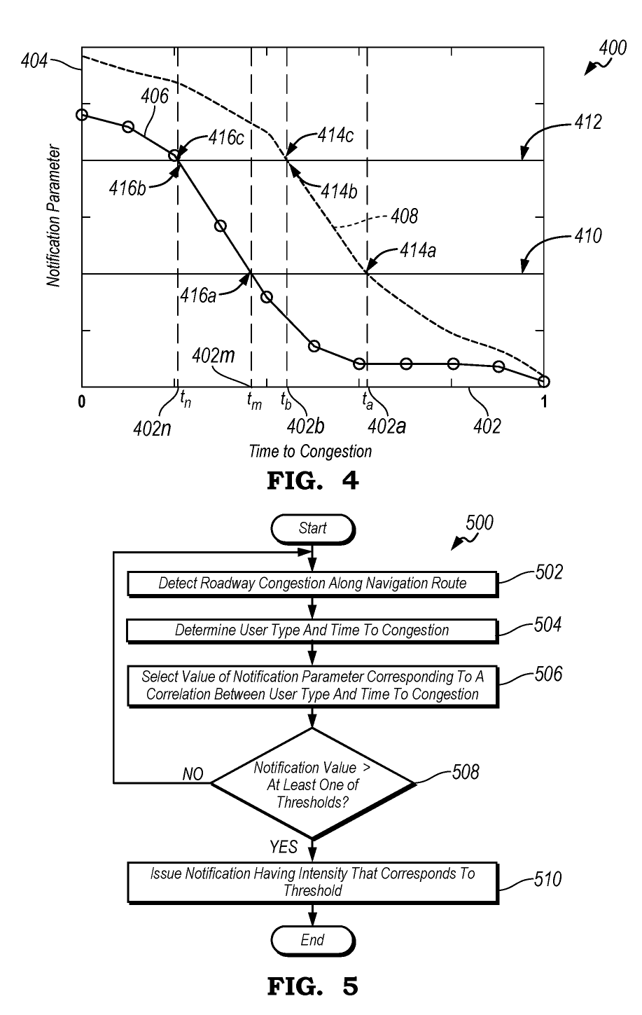

FIG. 4 illustrates an example diagram 400 for providing the personalized notification to the vehicle 102 operator based on a value of the notification parameter 176. The diagram 400 includes a time to congestion axis 402 and a notification parameter axis 404. First and second curves 406 and 408 may each be indicative of, for a corresponding user type, a change in the notification parameter 176 with respect to the time to congestion 402.

As one example, the notification parameter 176 that is less than a first threshold βₜₕᵣₑₛ 410 may have a smaller probability of resulting in an active alert and/or results in an active alert only to vehicle operators with the least amount of driving experience. As another example, the notification parameter 176 that is greater than the first threshold βₜₕᵣₑₛ 410 and less the second threshold βₜₕᵣₑₛ 412 may have a greater probability of resulting in an active alert, e.g., results in an active alert to a majority of vehicle operators, but fewer than all types of vehicle operators. The second threshold βₜₕᵣₑₛ 412 is greater than the first threshold βₜₕᵣₑₛ 410 such that the personalized notification value 176 that is greater than the second threshold δₜₕᵣₑₛ 412 has the greatest probability of resulting in an active alert and/or results in an active alert for all vehicle operator types.

In some instances, a first threshold βₜₕᵣₑₛ 410 and a second threshold δₜₕᵣₑₛ 412 may be indicative of an issued alert having a first intensity and a second intensity, respectively. In one example, intensity that corresponds to the first threshold βₜₕᵣₑₛ 410 may be less than intensity of the second threshold δₜₕᵣₑₛ 412. The congestion notification controller 162 may be configured to issue personalized congestion alerts having a first intensity in response to detecting that the first and second curves 406, 408 are greater than the first threshold βₜₕᵣₑₛ 410. The congestion notification controller 162 may be configured to issue personalized congestion alerts having a second intensity in response to detecting that the first and second curves 406, 408 are greater than the second threshold δₜₕᵣₑₛ 412.

Put another way, intensity of the issued congestion alerts may increase with an increase in the pers_notif_value as a period of time to congestion t_cong decreases. As one example, the congestion notification controller 162 may output a personalized notification, out_notif, based on the calculated pers_notif_value:

$$out\_notif = \{ \begin{matrix}1 & if \{ ( pers\_notif \_value \leq {β}_{thres} ) \\ 2 & if \{ ( {β}_{thres} < pers\_notif \_value \leq {δ}_{thres} ) \\ 3 & if \{ ( pers\_notif \_value > {δ}_{thres} )\end{matrix} , \qquad ( 3 )$$

where βₜₕᵣₑₛ may be the first threshold 410, δₜₕᵣₑₛ may be the second threshold, and the second threshold δₜₕᵣₑₛ may be greater than the first threshold βₜₕᵣₑₛ. In one example, the congestion notification controller 162 may forego issuing a driver notification, or issue a low intensity notification, in response to detecting that out_notif=1. As another example, the congestion notification controller 162 may issue a driver notification having medium intensity in response to detecting that out_notif=2. As still another example, the congestion notification controller 162 may issue a high intensity notification in response to detecting that out_notif=3.

As one example, in reference to the curve 408 corresponding to user A, value of the notification parameter 176 may be greater than the first threshold βₜₕᵣₑₛ 410 and less than the second threshold δₜₕᵣₑₛ 412 (indicated generally using arrows 414a, 414b, respectively), or when the time to congestion 402 is less than a first time to congestion tₐ 402a and greater than a second time to congestion t_{b} 402b. Thus, user A may receive a personalized notification having intensity corresponding to the first threshold βₜₕᵣₑₛ 410 when the time to congestion 402 is between the first time to congestion tₐ 402a and the second time to congestion t_{b} 402b. Further in reference to the curve 408, user A may receive another personalized notification having intensity corresponding to the second threshold δₜₕᵣₑₛ 412 when value of the notification parameter 176 is greater than the second threshold δₜₕᵣₑₛ 412, e.g., arrow 414c, or at a time when the time to congestion 402 is less than the second time to congestion t_{b} 402b.

Additionally or alternatively, in reference to the curve 406 corresponding to user B, value of the notification parameter 176 may be greater than the first threshold βₜₕᵣₑₛ 410 and less than the second threshold δₜₕᵣₑₛ 412 (indicated generally using arrows 416a, 416b, respectively), or when the time to congestion 402 is less than a third time to congestion tₘ 402m and greater than a fourth time to congestion tₙ 402n. User B, therefore, may receive a personalized notification having intensity corresponding to the first threshold βₜₕᵣₑₛ 410 at a time when the time to congestion 402 is between the third time to congestion tₘ 402m and the fourth time to congestion tₙ 402n. In some instances, user B may receive another personalized notification having intensity corresponding to the second threshold δₜₕᵣₑₛ 412 when value of the notification parameter 176 is greater than the second threshold δₜₕᵣₑₛ 412, e.g., arrow 416c, or at a time when the time to congestion 402 is less than the fourth time to congestion tₙ 402n.

FIG. 5 illustrates an example process 500 for issuing a roadway congestion notification. The process 500 may be performed, for example, by the congestion notification controller 162 of the vehicle 102 in communication with the GPS controller 146 over the in-vehicle network 142.

At operation 502, the congestion notification controller 162 detects that the vehicle 102 is approaching a roadway congestion along a navigation route of the vehicle 102. The traffic slowdown may be detected, for instance, via the GPS controller 146 and/or as a result of communication via the network 152. The congestion notification controller 162, at operation 504, determines user type of the vehicle 102 operator and a period of time remaining prior to reaching the detected upcoming congestion, i.e., a time-to-congestion. In an example, the congestion notification controller 162 may determine the time-to-congestion based on a current speed of the vehicle 102 and a current geographic location of the vehicle 102 with respect to the detected congestion 210.

At operation 506, the congestion notification controller 162 selects value of the notification parameter 176 that corresponds to the correlation between the user type and the time to congestion. The congestion notification controller 162, at operation 508, determines whether the selected value of the notification parameter 176 is greater than at least one of a plurality of thresholds of the notification parameter 176. The congestion notification controller 162 returns to operation 502 responsive to the value being less than any of the thresholds.

The congestion notification controller 162 proceeds to operation 510 responsive to the value of the notification parameter 176 being greater than at least one of the thresholds corresponding to the parameter 176. At operation 510, the congestion notification controller 162 issues, to the operator of the vehicle 102, a personalized congestion notification having an intensity corresponding to the threshold.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

1. A system for a vehicle comprising:
a positioning system configured to detect roadway congestion along a vehicle navigation route; and
a controller configured to select a notification value that corresponds to a correlation between a time to the congestion and a vehicle driver type indicative of a predicted driver reaction time and, responsive to the value being greater than a first threshold, issue an alert having volume and brightness corresponding to the first threshold, and, responsive to the value being greater than both the first threshold and a second threshold, issue the alert having second volume and brightness corresponding to the second threshold, wherein second volume and brightness are greater than the first volume and brightness.

2. (canceled)

3. The system of claim 1, wherein each of the thresholds includes a corresponding number of output sources activated for the alert and the number of sources of the second threshold is greater than the number of the first threshold.

4. The system of claim 1, wherein the predicted reaction time is based on one of a number of driving hours logged, driver eyesight acuity, driver age, or a level of driving experience previously selected by the driver indicative of one of a novice, an average driver, or an experienced driver.

5. The system of claim 1, wherein the controller is further configured to, prior to a comparison with the value, adjust respective values of the thresholds based on at least one of a plurality of environmental factors.

6. The system of claim 5, wherein the environmental factors include one of current weather, a current time of day, a current geographic location of the vehicle, or a current in-cabin noise level.

7. A method for a vehicle comprising:
responsive to a roadway congestion, selecting a personalized notification value corresponding to a correlation between a period of time prior to reaching the congestion and a previously-stored user type indicative of a predicted driver reaction time;
responsive to the value being greater than a first threshold, issuing a first alert having a first intensity corresponding to the first threshold; and,
responsive to the value being greater than the first threshold and a second threshold, issuing a second alert having a second intensity corresponding to the second threshold and being different from the first intensity, wherein the first and second intensities include corresponding volume and brightness.

8. The method of claim 7, wherein the period of time is determined based on current vehicle speed and a distance to a beginning of the congestion.

9. The method of claim 7, wherein the period of time of the first alert is greater than the period of time of the second alert.

10. The method of claim 7, wherein the volume and brightness of the second intensity are greater than the volume and brightness of the first intensity.

11. The method of claim 7, wherein the predicted reaction time is based on one of a number of driving hours logged, driver eyesight acuity, driver age, or a level of driving experience previously selected by the driver indicative of one of a novice, an average driver, or an experienced driver.

12. The method of claim 7 further comprising, prior to comparing the value and the thresholds, adjusting respective values of the thresholds based on at least one of a plurality of environmental factors.

13. The method of claim 12, wherein the environmental factors include one of current weather, a current time of day, a current geographic location of the vehicle, or a current in-cabin noise level.

14. A system for a vehicle comprising:
a positioning system configured to detect a roadway congestion along a navigation route being followed by the vehicle; and
a controller configured to select a notification value based on a correlation between a period of time remaining prior to reaching the congestion and a vehicle driver type indicative of predicted driver reaction time and, responsive to the value being greater than a first threshold, issue an alert having volume and brightness corresponding to the first threshold, responsive to the value being less than the first threshold, prevent issuing the alert, and, responsive to the value being greater than both the first threshold and a second threshold, issue a subsequent alert having volume and brightness greater than volume and brightness of the previous alert and corresponding to the second threshold.

15. (canceled)

16. The system of claim 14, wherein each of the thresholds further includes a corresponding number of output sources used for the alert and the number of sources of the second threshold is greater than the number of sources of the first threshold.

17. The system of claim 14, wherein the predicted reaction time is based on one of a number of driving hours logged, driver eyesight acuity, driver age, or a level of driving experience previously selected by the driver indicative of one of a novice, an average driver, or an experienced driver.

18. The system of claim 14, wherein the controller is further configured to, prior to a comparison with the value, adjust respective values of the thresholds based on at least one of a plurality of environmental factors.

19. The system of claim 18, wherein the environmental factors include one of current weather, a current time of day, a current geographic location of the vehicle, or a current in-cabin noise level.
